(19) United States
(12) Patent Application Publication
(10) Pub. No.: US 2009/0276458 A1
(43) Pub. Date: Nov. 5, 2009

(54) Adaptive Workflows Derived From Updates to Solution Building Block Architectures and Designs

(75) Inventors: Ingrid M. Moulckers, Austin, TX (US); Sandra K. Johnson, Cary, NC (US)

Correspondence Address: Greg Goshorn, P.C., 9600 Escarpment, Suite 745-9, AUSTIN, TX, 78749, US

(73) Assignee: INTERNATIONAL BUSINESS MACHINES CORPORATION, Armonk, NY (US)

(21) Appl. No.: 12/112,030

(22) Filed: Apr. 30, 2008

(51) Int. Cl. G06F 17/30

(52) U.S. Cl. 707/104.1; 707/E17.044

(57) ABSTRACT

Provided is a method for the adaptive testing, updating and verification of a building block architecture and design, such as a solution building block (SBB) architecture design, in the event of a change to the building block architecture and or a component of the architecture. Typically, an on-demand, custom solution to a user or business's computing needs has a specific architecture and a common metadata definition that defines attributes and dependencies among components. When a specific, or target, component of the architecture, or SBB, is replaced or modified, the metadata associated with the new or modified component is placed in a building block repository. The system captures or recognizes the event and automatically generates workflows that enable a user to test, validate, implement and, if necessary, make additional changes to the architecture.

### BACKGROUND

1. Technical Field

The claimed subject matter relates generally to solution building blocks (SBBs) and, more specifically, to a method of providing automatic workflow scenarios to enable a user to test, validate and implement changes to a computing architecture.

2. Description of the Related Art

International Business Machines Corp. (IBM) of Armonk, N.Y. has been at the forefront of new paradigms in business computing. For decades, the typical paradigm for business computing is that custom business applications had to be specifically designed and built for every business need. Of course, most custom business applications benefited from commonly-available, standardized applications. For example, a business that requires a database management system (DBMS) has several vendors from which to choose and each choice typically provides many of the same necessary features and interfaces to an application developer. However, a DBMS is only one of a multitude of possible components that may be required to implement a business solution.

There are several approaches to the development of a business software solution for a particular business. One approach focuses on specific components, or solution building blocks (SBBs), designed for an information technology (IT) environment. SBBs are preconfigured bundles of interoperable hardware and middleware that enable a business or infrastructure solution to be implemented. Examples of middleware include, but are not limited to, web servers, application servers and database servers. Examples of hardware include, but are not limited to, servers, data storage and associated system management software. In other words, SBBs are reusable assets that can be deployed in many different engagements for a diverse set of business and infrastructure solution offerings.

Typically, SBBs require additional integration to develop and deploy a complete solution. There exist architectures and associated tools designed to enable a developer to quickly assemble middleware and hardware components into SBBs. However, these existing technologies and methodologies do not provide adaptive functionality to enable automatic updates of the individual components of an SBB in the event of changes to the architecture or design of a targeted component.

Two terms that may be useful to clarify are the terms “application” and “solution.” In some cases, an application solves several problems and as a result may be considered a solution. However, usually the term “solution” refers to an application because a solution solves a target set of problems. A solution is usually broader than an application because it resolves or addresses horizontal as well as vertical business problems. Solutions are typically delivered for the purpose of running a business end-to-end and not just focused on a portion (or application of the business). An application is applied to solve a set of problems for a business and might be applied to solve another set of problems of the same kind for another customer.

### Summary of the Claimed Subject Matter

Provided is a method for the adaptive testing, updating and verification of a building block architecture and design, such as a solution building block (SBB) architecture design, in the event of a change to the building block architecture and or a component of the architecture. The remainder of the Specification focuses primarily on the relationship of the claimed subject matter to SBBs, although it should be understood that the disclosed technology is equally applicable to any building block architecture, many of which should familiar to those with skill in the computing arts.

Typically, an on-demand, custom solution to a user or business's computing needs has a specific architecture and a common metadata definition that defines attributes and dependencies among components. When a specific, or target, component of the architecture, or SBB, is replaced or modified, the metadata associated with the new or modified component is placed in a building block repository. The system captures or recognizes the event and automatically generates workflows that enable a user to test, validate, implement and, if necessary, make additional changes to the architecture.

Alerts to those users, or participants, associated or involved in the lifecycle, maintenance and management of the SBB's are transmitted to the participants to inform them that a workflow process has been initiated. Any particular workflow includes, but is not limited to, requests for a participant to take one or more actions and make decisions at decision checkpoints. Decisions and actions taken at various points trigger actions that complete, modify or cancel a corresponding SBB update process or processes.

After an architecture model for a business solution has been created or manipulated, attributes of individual components allow for the correlation of the components' architecture with metadata relating to the management of the lifecycle of the components. The metadata includes information about roles and responsibilities of those who should be alerted when a workflow has been triggered. Using this metadata about roles and responsibilities, the disclosed technology alerts a user that actions and decisions are required to complete the workflow and publish, withdraw, test and/or take other actions related to the update of the SBBs.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE FIGURES

A better understanding of the claimed subject matter can be obtained when the following detailed description of the disclosed embodiments is considered in conjunction with the following figures.

FIG. 1 is a block diagram of one example of a computing system that implements aspects of the claimed subject matter.

FIG. 2 is a block diagram of a solution development system architecture that employs the claimed subject matter, including a solution building block management system (SBBMS) and a solution building block workflow generator (SBBWG), first introduced in conjunction with FIG. 1.

FIG. 3 is a block diagram of the SBBMS of FIGS. 1-3 showing the relationships among various components.

FIG. 4 is a block diagram of the SBBWG of FIGS. 1, 2 and 4 showing the relationships among various components.

FIG. 5 is a block diagram showing the update of the solution development architecture of FIG. 2 as implemented by the SBBMS and SBBWG of FIGS. 1-4.

FIG. 6 is a flowchart of an Execute SBBWG process that implements one aspect of the claimed subject matter.

FIG. 7 is a flowchart of Modify Architecture process that implements one aspect of the Execute SBBMS, introduced in FIG. 6.

FIG. 8 is a flowchart of an Execute SBBWG process that implements the claimed subject matter.

### DETAILED DESCRIPTION OF THE FIGURES

Although described with particular reference to a solution building block (SBB) architecture, the claimed subject matter can be implemented in any information technology (IT) system in which the testing, validating and implementation of components are desirable. Those with skill in the computing arts will recognize that the disclosed embodiments have relevance to a wide variety of computing environments in addition to those described below. In addition, the methods of the disclosed technology can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for generating workflows with respect to a solution architecture. The term “programmed method”, as used herein, is defined to mean one or more process steps that are presently performed; or, alternatively, one or more process steps that are enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

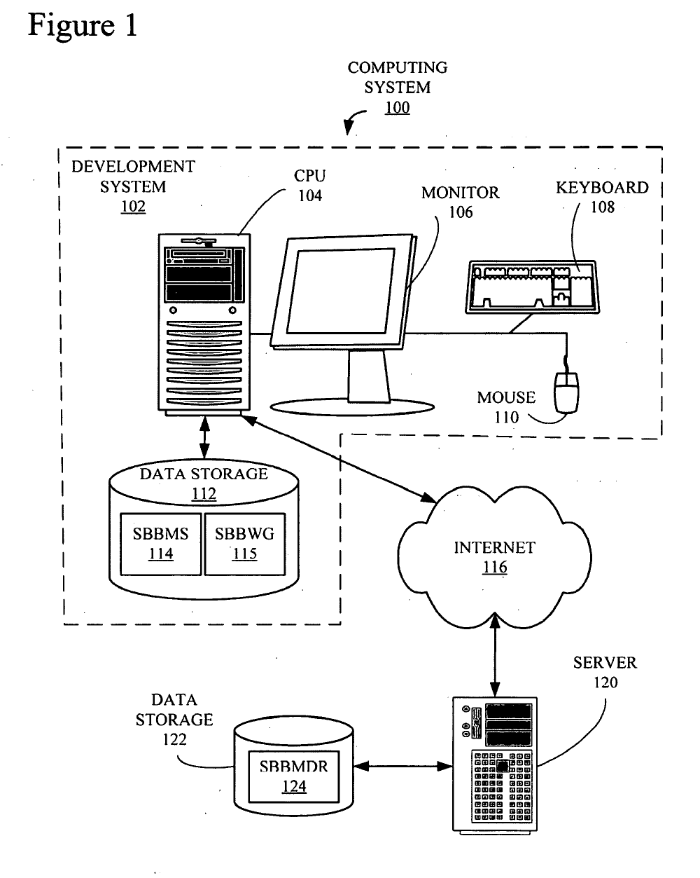

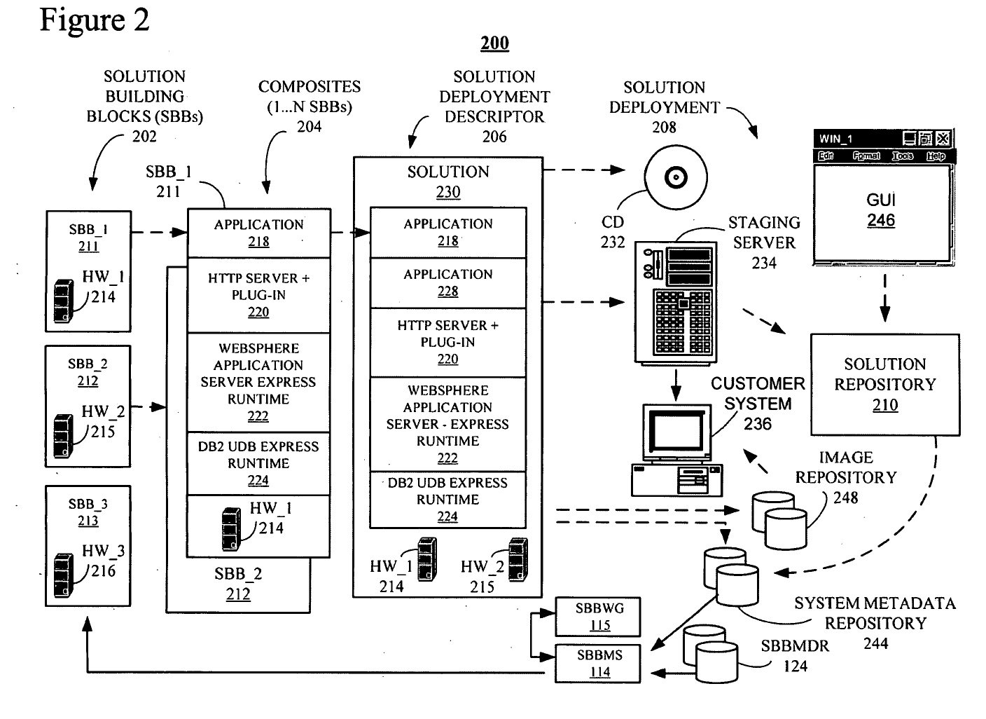

Turning now to the figures, FIG. 1 is a block diagram of one example of a computing system architecture 100 that implements aspects of the claimed subject matter. A development system 102 includes a central processing unit (CPU) 104, coupled to a monitor 106, a keyboard 108 and a mouse 110, which together facilitate human interaction with computing system 100 and development system 102. Also included in development system 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown). Data storage 112 is illustrated storing a solution building block monitoring system (SBBMS) 114 and a solution building block workflow generator (SBBWG) 115. SBBMS 114 and SBBWG 115 are described in more detail below in conjunction with FIGS. 2-8.

Development system 102 and server computer 120 are connected to the Internet 116. Although in this example, development system 102 and server 120 are communicatively coupled via the Internet 116, although they could also be coupled through any number of communication mediums such as, but not limited to, a local area network (LAN) (not shown). Further, it should be noted there are many possible computing system configurations, of which computing system 100 is only one simple example. Server 120 is coupled to a data storage 122, which may either be incorporated into server 120 i.e. an internal device, or attached externally to server 120 by means of various, commonly available connection devices such as but not limited to, a universal serial bus (USB) port (not shown).

Data storage 122 stores a SBB metadata repository (SBBMDR) 124. SBBMDR 124 stores information about individual SBBs that are available for inclusion in a particular business solution and the relationship among the SBBs. In other words, SBBMDR 124 is a library of available SBBs that is maintained for the benefit of developers creating business solutions. Examples of information stored in SBB metadata repository 124 include what the individual SBBs are and version numbers. Also stored is information relating to how SBBs may be physically and logically arranged architecturally, how each SBB is constructed, the tools necessary to adapt, deploy, reconstruct and so on each, and any additional information necessary to utilize SBBs. In addition, repository 124 stores information concerning the roles and responsibilities of particular users with respect to individual SBBs. The use of SBBMDR 124 is described in more detail below in conjunction with FIGS. 2-8.

FIG. 2 is a block diagram of solution development system 200 showing some exemplary components and business solution distribution elements. System 200 includes solution building blocks (SBBs) 202, composites (1 . . . N SBBs) 204, a solution deployment descriptor phase 206, a solution deployment phase 208 and a solution repository 210.

SBBs 202 includes several individual SBBs, specifically a SBB_1 211, a SBB_2 212 and a SBB_3 213. In this example, each of SBBs 211-213 include, in addition to middleware described below, a hardware component, or HW_1 214, HW_2 215 and HW_3 216, respectively. As described above in the Description of the Related Art, examples of SBBs 211-213 include middleware such as, but are not limited to, web servers, application servers and database servers. In addition, any particular SBB 211-213 may include other SBBs (not shown), i.e. nested SBBs. Examples of HW_1 214 include hardware such as, but are not limited to, servers, data storage and associated system management software. Each of components 211-214 may be selected for inclusion in a particular solution architecture and represent preconfigured, interoperable software and/or hardware bundles. It should be understood that any system such as system 200 would typically include more than three SBBs but that for the sake of simplicity, only SBBs 211-213 are illustrated. In this example, SBB_1 211 and SBB_2 212 have been selected for inclusion in composites 204.

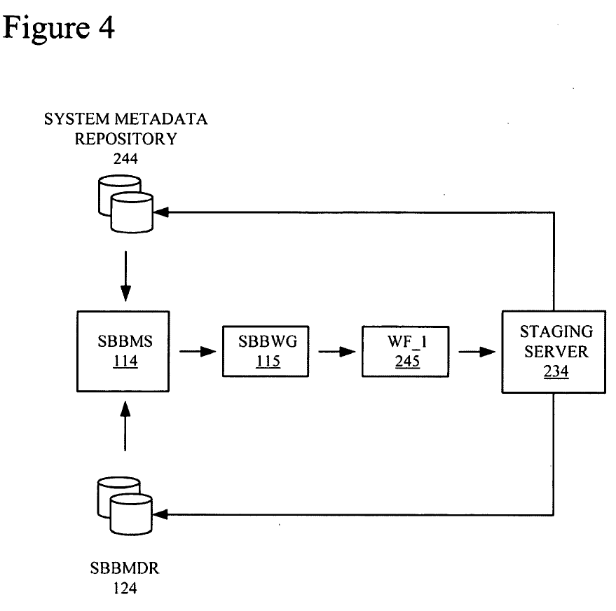

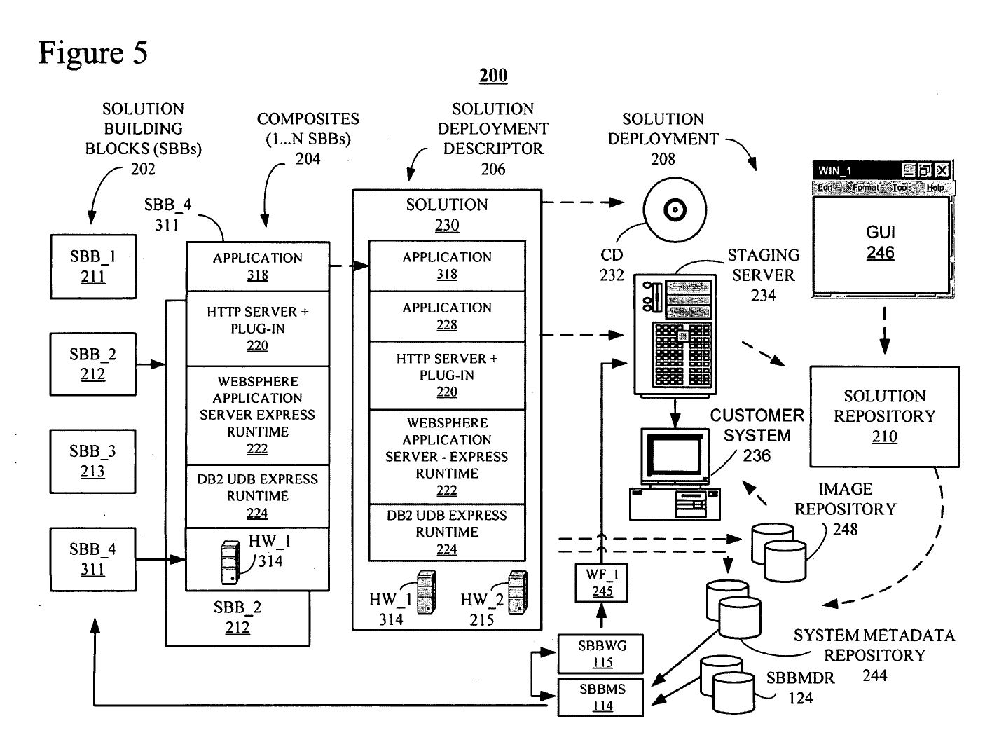

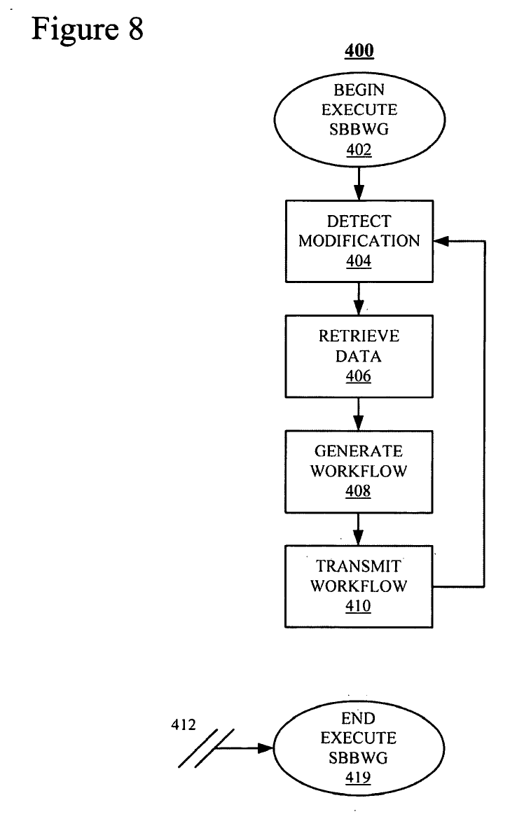

SBBMS 114 is employed to modify the selection of SBBs 211-213 when component requirements change. SBBWG 115 is employed to detect changes to the selection of SBBs 211-213 and to generate test scenarios in response so that an administrator or user is able to verify that a particular selection functions as intended and meets a user's requirements (see FIG. 5). The use of SBBWG 115 is described in more detail below in conjunction with FIGS. 4 and 8.

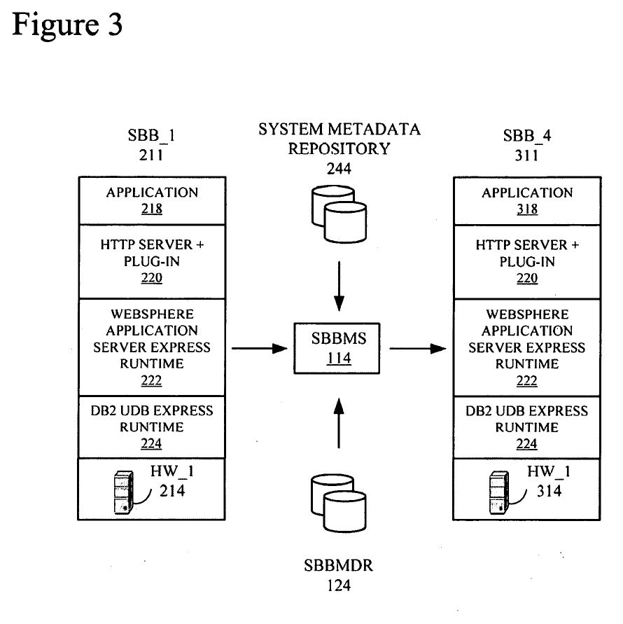

FIG. 3 is a block diagram of SBBMS 114 of FIGS. 1-3 showing the relationships among various additional components. SBB_1 211 (FIG. 2) is illustrated showing core components 218, 220, 222,224 and 214 (FIG. 2). Information, or metadata, about SBB_1 211 is stored in both SBBMDR 124 (FIGS. 1 and 2) system metadata repository 244 (FIG. 2). As explained above in conjunction with FIGS. 1 and 2 metadata associated with SBB_1 211 is stored in system metadata repository 244 because SBB_1 211 is incorporated into solution 230 and solution repository 210. Metadata associated with SBB_1 211 is stored in SBBMDR 124 because SBB_1 211 is an available component for a solution such as solution 230.

In this example, metadata associated with SBB_1 211 in repositories 124 and 244 are not consistent, i.e. changes have been made to SBB_1 211 after SBB_1 211 was incorporated into solution 230. Changes can be modification such as, but not limited to, upgrades, patches, changes to available or desirable hardware and so on. SBBCM 114 detects the differences between metadata stored in SBBMDR 124 and system metadata repository 244 and modifies SBB_1 114 so that solution 230 may also be updated if necessary.

Since SBB_1 114 may continue to be available as a component to any particular solution, SBBCM 114 generates another SBB, i.e. a SBB_4 311. SBB_4 311 includes several of the same components as SBB_1 211, specifically components 218, 220, 222 and 224. However, application 218 is replaced by an application 318 and HW_1 214 is replaced by different hardware, or HW_4 314. In this example, application 218 has been replaced by an upgrade, or application 318, and the upgrade necessitates a hardware substitution, or a replacement of HW_1 214 by HW_4 314.

FIG. 4 is a block diagram of SBBWG 115 of FIGS. 1 and 2 showing the relationships among various other components. SBBWG 115 (FIG. 1) is employed to generate testing scenarios employed by users to publish, test, validate, withdraw and other implement various other actions with respect to any modification in the selection of SBBs 211-213 for any particular solution architecture. In this example, SBBWG 115 is stored in data storage 112 (FIG. 1) and executes on development server 102 (FIG. 1).

Briefly, SBBWG 115, which is coupled to SBBMS 114, detects proposed modifications to solution 230 (FIG. 2). As explained above in conjunction with FIG. 3, SBBMS 114 receives information from system metadata repository 244 (FIGS. 2 and 3) and SBBMDR 124 (FIGS. 1-3) and implements changes to, in this example, SBB_1 211 (FIGS. 2 and 3) generating SBB_4 311 (FIG. 3) in the process. SBBWG 115 detects these actions and generates a workflow scenario, i.e. WF_1 245 (see FIG. 5), which is loaded into staging server 234 (FIG. 2). Once WF_1 245 is loaded on staging server 234, requests for actions associated with WF_1 245 are transmitted to the appropriate users and administrators for action. In this manner, changes to solution 230 are tested and verified. In this example, testing and verification are executed either on staging server 234 on solution 230 (FIG. 2) or implemented and tested on customer system 236 (FIG. 2).

Information, or feedback, from testing and validation actions taken by users and administrators are transmitted back to SBBMS 114 via system metadata repository 244 (FIGS. 2 and 3) and SBBMDR 124 (FIGS. 1-3) so that any additional modifications may be implemented. Modifications may include, but are not limited to, such actions as the withdrawal or modification of a particular component or implementation and the addition of other additional components discovered during the testing and validation stage to be necessary. Of course, additional modifications are also re-submitted for testing and validation in a loop until a satisfactory solution 230 is generated. Specific processes and methods associated with SBBWG 115 are described in more detail below in conjunction with FIGS. 5-8.

FIG. 5 is a block diagram showing the update of a particular solution as implemented by SBBMS 114 of FIGS. 1-3. FIG. 5 includes most of the components and stages described above in conjunction with FIG. 2. Components and stages duplicated from FIG. 2 are not described again in conjunction with FIG. 4. In this example, in addition to SBBs 211-213, solution build blocks 202 (FIG. 2) includes SBB_4 311, introduced above in conjunction with FIG. 3. As explained above, SBB_4 311 is an upgrade of SBB_1 211 that necessitated an upgrade from HW_1 214 to HW_4 314. In addition, WF_1 245, first introduced in conjunction with FIG. 4, is illustrated.

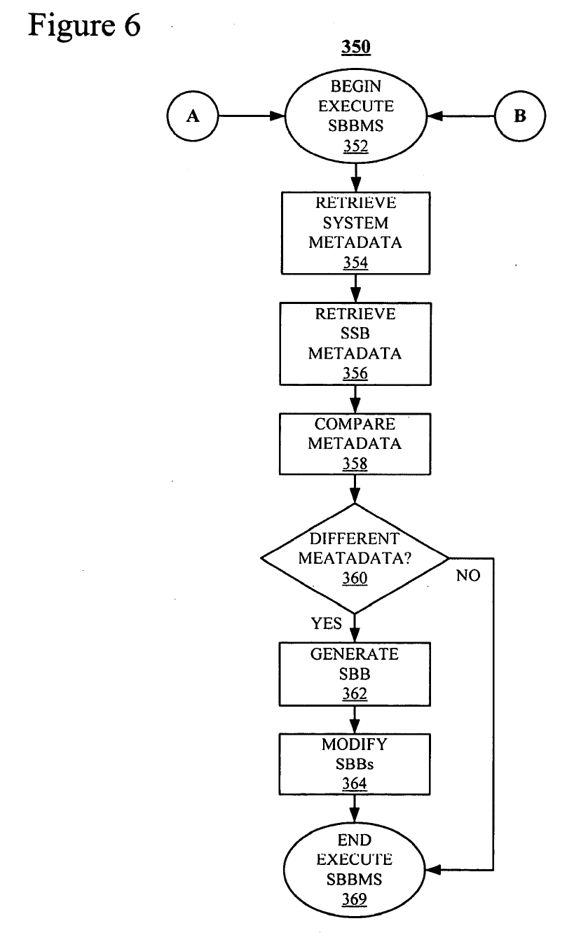

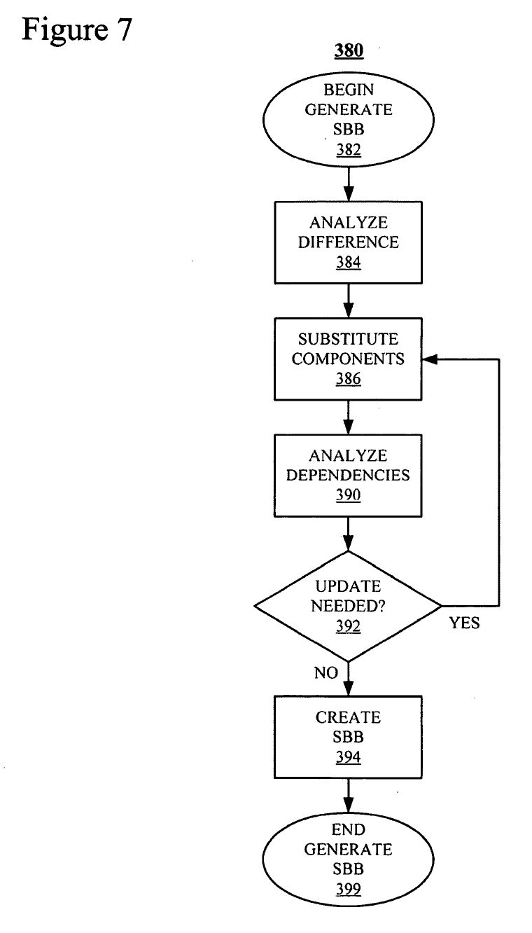

In this example, the upgrade is propagated through composites 204, solution deployment descriptor 206, solution deployment 208 and solution repository 210. In addition, system metadata repository 244 is updated to reflect the modifications to the system architecture. The detection that the upgrade is available, the generation of SBB_4 311 and the generation of a modified solution building blocks phase 202 are implemented by SBBMS 114. Processes associated with the detection and upgrade are executed by SBBMS 114 and described below in conjunction with FIGS. 6 and 7.

As explained above in conjunction with FIG. 4, SBBWG 115 (FIGS. 1, 2 and 4) detects modifications to the system architecture and generates test scenarios such as WF_1 245 (FIG. 4).

FIG. 6 is a flowchart of an Execute SBBMS process 350 that implements the claimed subject matter. In the description below, the execution of process 350 is occurring after system 200 is configured as described in FIG. 2 and before as described in FIG. 4. In other words, process 350 is described as implementing the changes in the solution architecture from those describe in FIG. 2 to those in FIG. 4. Process 350 is stored in data storage 112 (FIG. 1) and executed on CPU 104 (FIG. 1) of development system 102 (FIG. 1).

It should be noted that process 350 may be initiated in a number of ways, although for the sake of simplicity only two (2) are shown, i.e. an initiation event A and an initiation event B. In this example, event A represents a periodic check of the system, initiated either by a system administrator or automatically generated by a system timer set to a configurable parameter. Event B represents a modification to the system architecture as represented in solution repository 210 (FIGS. 1 and 3). The particular manner of initiation is not specified in this example but could be the result of event A, event B or some other event.

Process 350 starts in a “Begin Execute SBBMS” block 352 and proceeds immediately to a “Retrieve System Metadata” block 354. During block 354, process 350 retrieves metadata from system metadata repository 244 (FIGS. 2 and 4). As explained above in conjunction with FIG. 2, repository 244 stores metadata associated with software and hardware components currently installed in solution repository 210 (FIGS. 2 and 4) as part of the business solution 230 (FIGS. 2 and 4). During a “Retrieve SBB Metadata” block 356, process 350 retrieves metadata associated with SBB building blocks 202 (FIGS. 2 and 4), stored in SBBMDR 124 (FIGS. 1-4).

During a “Compare Metadata” block 358, process 350 compares the metadata retrieved during block 354 with the metadata retrieved during block 356 to determine whether or not any differences exist. A difference may exist, for example, if a particular SBB, such as SBB_1 214 (FIGS. 2 and 4), has been upgraded, i.e. a newer version has been released. The version number of the various components is typically stored in conjunction with the metadata. Those with skill in the computing arts should appreciate that are many reasons for components in solution repository 210 to differ from the available SBBs 202. Another example of a difference in metadata repositories 124 and 244 occurs if a user has modified the system architecture stored in conjunction with solution repository 210. For example, if a system administrator has updated system security requirements for a middleware or application component in response to certain business requirements, the architectural design may also be modified. Such a modification would cause an update in the SBB metadata repository 244 that would be detected by process 350.

During a “Different Metadata?” block 360, process 350 determines whether or not a difference has been detected during block 358. If so, process 350 proceeds to a “Generate SBB” block 362. During block 358, a new SBB is created, as explained above in conjunction with FIG. 3. The process of generating the SBB is described in more detail below in conjunction with FIG. 6.

During an “Modify SBBs” block 364, the SBB generated during block 362 is added to solution building blocks 202 (FIGS. 2 and 4). Finally, once the modified SBB architecture has been generated during block 364, or, during block 360, process 350 has determined that metadata repositories 244 and 124 are consistent with each other, control proceeds to an “End Execute SBBMS” block 369 in which process 350 is complete.

FIG. 7 is a flowchart of Generate SBB process 380 that implements one aspect of Execute SBBMS process 350, introduced in FIG. 5. Process 380 corresponds to Generate SBB block 362 (FIG. 5) of process 350. As part of process 350, process 380 is also stored in data storage 112 (FIG. 1) and executed on CPU 104 (FIG. 1) of development system 102 (FIG. 1).

Process 380 starts in a “Begin Generate SBB” block 382 and proceeds immediately to an “Analyze Difference” block 384. During block 384, process 380 analyzes the differences detected during Different Metadata? Block 360 (FIG. 5) of process 350. Types of thing analyzed include, but are not limited to, superseded version numbers or entirely different components that have been substituted for others in either system metadata repository 244 (FIGS. 2 and 4) and/or SBBMDR 124 (FIGS. 1-4).

During a “Substitute components” block 386, the architecture design stored in solution repository 230 is modified to reflect the updated component or components. During an “Analyze Dependencies” block 390, process 380 determines if substitutions implemented during block 386 have created a need to modify additional components. As described above, metadata repositories 244 and 124 include information on dependencies among components. For example, process 380 may determine that a substitution of SBB_1 211 (FIG. 2-4) with SBB_4 311 (FIGS. 3 and 4) requires that associated hardware HW_1 214 (FIGS. 2-4) must be replaced with HW_4 314 (FIGS. 3 and 4).

During an “Update Needed?” block 392, process 380 determines based upon the analysis executed during block 390 whether or not the component substitutions implemented during block 386 have created dependencies in other components that need to be addressed. If additional component substitutions are required, process 380 returns to block 386 during which the substitutions are implemented and processing continues as described above. If, during block 392, process 380 determines that additional substitutions are not required, control proceeds to an “End Generate SBB” block 399 in which process 380 is complete.

FIG. 8 is a flowchart of an Execute SBBWG process 400 that implements the claimed subject matter. Process 400 implement the functionality of SBBWG 215 (FIGS. 1, 2, 4 and 5). As mentioned above in conjunction with FIG. 4, in this example SBBWG 215 and thus process 400, is stored on data storage 112 (FIG. 1) and executes on development computer 102 (FIG. 1).

Process 400 starts in a “Begin Execute SBBWG” block 402 and proceeds immediately to a “Detect Modification” block 404. During block 404, process 400 determines that SBBMS 114 has been employed to update a particular solution 230 as described above in conjunction with Execute SBBMS process 350 of FIG. 6. Process 400 determines that an update is either pending or in progress based upon a signal from SBBMS 114 (FIGS. 1-3 and 5). During a “Retrieve Data” block 406, process 400 gathers data, transmitted by SBBMS 114, related to the pending update. Examples of transmitted data include, but are not limited to, information on updated components and corresponding metadata. As described above in conjunction with FIG. 1, metadata includes information about individual SBBs that are available for inclusion in a particular business solution, the relationship among SBBs, how individual SBBs are used, version numbers, information relating to the physical and logical architectural arrangement of SBBs, how each SBB is constructed, the tools necessary to adapt, deploy, reconstruct a particular SBB and information concerning the roles and responsibilities of particular users with respect to individual SBBs. Mush of this information is not required by SBBWG 115 so SBBMS 114 may selectively transmit only relevant information. OF particular interest to SBBWG 115 is the information on the roles and responsibilities of particular users with respect to individual SBBs.

During a “Generate Workflow” block 408, process 400 builds one or more test scenarios based upon the information transmitted during block 406. Test scenarios may be designed to be automatically executed by the system under test and/or may consist of directives to particular users and administrators to take some one or more actions. During a “Transmit Workflow” block 410, the workflows, such as WF_1 245 (FIGS. 4 and 5) generated during block 408 are transmitted to the appropriate location, either application associated with solution 230 or particular users for execution. Feedback from the transmitted workflows are transmitted back to SBBMS 114, which initiates any addition action that may be necessary to test or validate the pending updates. Additional actions may include, but are not limited to, adding additional components, withdrawing components and proceeding with an update.

Process 400 is designed to execute in the background as long as development system 102 is powered. An asynchronous interrupt 412 provides an administrator to terminate execution. Finally, if interrupt 412 is signaled, control proceeds to an “End Execute SBBWG” block 419 in which process 400 is complete.

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements and/or additional, less or modified blocks performed in the same or a different order.

We claim:

1. A method, comprising:
detecting a modification to metadata, stored in a building block repository, associated with a first computing component incorporated into a computing solution;
generating a second computing component based upon the detected modification to the metadata;
storing the second computing component in the building block repository;
updating the computing solution, the updating comprising replacing the first computing component with the second computing component;
generating a workflow scenario to test the updated computing solution; and
executing the workflow scenario.

2. The method of claim 1, further comprising:
identifying an actor to execute the workflow scenario; and
transmitting the workflow scenario to the identified actor for execution.

3. The method of claim 2, wherein the identified actor is an individual user with responsibilities corresponding to the workflow scenario.

4. The method of claim 2, wherein the identified actor is an automated system responsible for executing actions corresponding to the workflow scenario.

5. The method of claim 1, further comprising transmitting a report corresponding to the execution of the workflow scenario.

6. The method of claim 5, further comprising:
generating a third computing component corresponding to the second computing component if the transmitted report indicates that the computing solution is not meeting expectations in conjunction with the second computing component;
storing the third computing component in the building block repository;
updating the computing solution by replacing the second computing component with the third computing component;
generating a second workflow scenario to test the second updated computing solution; and
executing the second workflow scenario.

7. The method of claim 5, further comprising repeating the generating, storing updating, executing and transmitting with respect to additional computing solutions, workflow scenarios and reports as long as an additional transmitted report indicates that the computing solution is not meeting expectations in conjunction with a corresponding additional component.

8. A system, comprising:
a processor;
memory coupled to the processor; and
logic, stored on the memory for execution on the processor, for:
detecting a modification to metadata, stored in a building block repository, associated with a first computing component incorporated into a computing solution;
generating a second computing component based upon the detected modification to the metadata;
storing the second computing component in the building block repository;
updating the computing solution, the updating comprising replacing the first computing component with the second computing component;
generating a workflow scenario to test the updated computing solution; and
executing the workflow scenario.

9. The system of claim 8, further comprising logic, stored on the memory for execution on the processor, for:
identifying an actor to execute the workflow scenario; and
transmitting the workflow scenario to the identified actor for execution.

10. The system of claim 9, wherein the identified actor is an individual user with responsibilities corresponding to the workflow scenario.

11. The system of claim 9, wherein the identified actor is an automated system responsible for executing actions corresponding to the workflow scenario.

12. The system of claim 8, further comprising logic, stored on the memory for execution on the processor, for: transmitting a report corresponding to the execution of the workflow scenario.

13. The system of claim 12, further comprising logic, stored on the memory for execution on the processor, for:
generating a third computing component corresponding to the second computing component if the transmitted report indicates that the computing solution is not meeting expectations in conjunction with the second computing component;
storing the third computing component in the building block repository;
updating the computing solution by replacing the second computing component with the third computing component;
generating a second workflow scenario to test the second updated computing solution; and
executing the second workflow scenario.

14. The method of claim 12, further comprising logic, stored on the memory for execution on the processor, for repeating the generating, storing updating, executing and transmitting with respect to additional computing solutions, workflow scenarios and reports as long as an additional transmitted report indicates that the computing solution is not meeting expectations in conjunction with a corresponding additional component.

15. A computer programming product, comprising:
a memory; and
logic, stored on the memory for execution on a processor, for:
detecting a modification to metadata, stored in a building block repository, associated with a first computing component incorporated into a computing solution;
generating a second computing component based upon the detected modification to the metadata;
storing the second computing component in the building block repository;
updating the computing solution, the updating comprising replacing the first computing component with the second computing component;
generating a workflow scenario to test the updated computing solution; and
executing the workflow scenario.

16. The computer programming product of claim 15, further comprising logic, stored on the memory for execution on the processor, for:
identifying an actor to execute the workflow scenario; and
transmitting the workflow scenario to the identified actor for execution.

17. The computer programming product of claim 16, wherein the identified actor is an individual user with responsibilities corresponding to the workflow scenario.

18. The computer programming product of claim 15, further comprising logic, stored on the memory for execution on the processor, for: transmitting a report corresponding to the execution of the workflow scenario.

19. The system of claim 18, further comprising logic, stored on the memory for execution on the processor, for:
generating a third computing component corresponding to the second computing component if the transmitted report indicates that the computing solution is not meeting expectations in conjunction with the second computing component;
storing the third computing component in the building block repository;
updating the computing solution by replacing the second computing component with the third computing component;
generating a second workflow scenario to test the second updated computing solution; and
executing the second workflow scenario.

20. The method of claim 18, further comprising logic, stored on the memory for execution on the processor, for repeating the generating, storing updating, executing and transmitting with respect to additional computing solutions, workflow scenarios and reports as long as an additional transmitted report indicates that the computing solution is not meeting expectations in conjunction with a corresponding additional component.
